(19) United States
(12) Patent Application Publication
(10) Pub. No.: US 2014/0289011 A1
(43) Pub. Date: Sep. 25, 2014

(54) PARI-MUTUEL PREDICTION MARKETS AND THEIR USES

(71) Applicants: MERCK SHARP & DOHME CORP., Rahway, NJ (US); PROPHE INC., Skillman, NJ (US)

(72) Inventors: David Rubin, New Hope, PA (US); Simon Tomlinson, Skillman, NJ (US); Jennifer Shira Kessler, San Francisco, CA (US)

(21) Appl. No.: 14/353,361

(22) PCT Filed: Oct. 23, 2012
(86) PCT No.: PCT/US2012/061407

§ 371 Date: Apr. 22, 2014

Related U.S. Application Data
(60) Provisional application No. 61/552,519, filed on Oct. 28, 2011.

(51) Int. Cl. G06Q 30/02

(52) U.S. Cl. CPC G06Q 30/0202
USPC 705/7.31

(57) ABSTRACT

Computer-implemented methods and apparatus for generating prediction markets are described to gauge business uncertainties surrounding a project with an uncertain timeline and/or an uncertain result. Such prediction markets can be used in any industry segment and across business functions, including research and development (R&D), marketing, executive functions and others. Traditional prediction markets, like equity markets, require liquidity for success. By introducing a pari-mutuel prediction input platform, the present invention describes a modified prediction market that elicits more accurate predictions surrounding business decisions.

### FIELD OF THE INVENTION

The present application generally relates to prediction markets for gauging the potential outcome of a milestone or goal related to a project with an uncertain timeline and/or uncertain result. More particularly, the application relates to a method and apparatus for creating a prediction market data output of relative probabilities for choosing a potential outcome of an event occurring in the future. Ranking potential outcomes using predicted probabilities can assist an organization with making business decisions, such as ranking business priorities, making investment choices and time-ordering. Such prediction markets can be used in any industry segment and across business functions, including research and development (R&D), marketing, executive functions and others. As an example, decision making in the pharmaceutical industry can benefit from use of the disclosed prediction market methodology to better assess commercial, scientific and technical risk in drug development by leveraging the knowledge dispersed throughout a particular organization and/or in the industry.

### BACKGROUND OF THE INVENTION

Prediction markets are speculative markets for the purpose of making predictions, reflecting a stable consensus of a large number of opinions about the likelihood of potential outcomes associated with given events. A prediction market is a betting intermediary designed to aggregate opinions about events of particular interest or importance, predicting the “odds” (or probabilities) of a certain outcome occurring. The underlying principle is that the aggregate wisdom of a crowd will be more accurate than the predictions of a limited number of experts. The art of prediction markets lies in the means in which the wisdom of the crowd is extracted.

A traditional method for assessing a crowd's prediction is through the style of a futures market. Assets are created whose final cash value is tied to a particular event. A market predicts an event occurring in the future (e.g., “Event X will occur.”). The current market price (i.e., what people are willing to pay for a stake in the event ultimately occurring) can then be interpreted as a prediction of the probability of the event occurring. Holding a share in this market means one “wins” a defined sum of money if the event occurs. However, participants can buy and sell these shares to one another for a price that is dictated by traditional market trading rules (like a stock market). It is this action of buying and selling that determines the market price and is translated into the market's prediction of the event occurring.

As an example of how prediction markets may be implemented, suppose a market is tied to the following event: Drug X will advance to Phase III by January 2012. Holding a share in this market entitles the winner to $100 if Drug X advances to Phase III by January 2012. If Drug X fails to move into Phase III by January 2012, the share is worth $0. Like in a traditional stock market, participants can bid for shares at specified prices and ask to sell their shares at specified prices. If participants are willing to sell their shares at $10, this demonstrates that they have little confidence in their share ultimately being worth $100. However, if participants are willing to pay $90 for the opportunity to win $100, they are demonstrating confidence in the event occurring. As participants trade shares, the market determines a general consensus of the fair price for a chance at gaining $100 for the event occurring, which translates to the participants' confidence in Drug X advancing to Phase III by January 2015.

Traditional prediction markets, like equity markets, require liquidity for success. “Liquidity” means that participants have the ability to always find buyers acid sellers when they want to engage in a transaction. In other words, the “price” is hot determined by relative supply and demand, like a commodity, but is determined solely by the buyers' and sellers' view of the potential outcome of the underlying event. It is this infinite liquidity that allows the markets to function efficiently and for the price to accurately reflect the consensus view on probability of the event occurring. Liquidity is driven by the following criteria: (a) changing information and certainty across participants; (b) frequent participation; (c) inability for market manipulation; (d) a desire by participants to accept a certain level of risk in exchange for a certain level of reward; (e) diversity of opinions and information; (f) incentives for making correct predictions; and, (g) a reasonable level of relevant knowledge, though not necessarily subject matter expertise, across all participants. The market structure described above would not function in situations where circumstances do not meet the requirements for liquidity.

When the requirements for liquidity are not met, a traditional prediction market platform is an inefficient means to make decisions related to business uncertainties. This is often the case, for example, when making business decisions in focused, high-tech business environments, such as during pharmaceutical research and development (R&D). For example, in these business environments, the pace of change can be relatively slow such that milestones are far apart and key changes happen yearly, not daily or weekly. Employees' (i.e., participants') jobs are often directly related to events being predicted and, thus, manipulation is possible (e.g., meeting timelines, experimental outcomes). Personal investment in a “positive” outcome occurring opens the possibility that employees/participants may advocate for one particular outcome over many possible outcomes, also increasing the likelihood of market manipulation. A conservative culture among employees/participants with scientific training may also limit risk-taking when making predictions, requiring instead ‘hard proof’ for assessments. Lastly, it is unlikely to have a sufficient number participants/employees in a focused business environment to have true diversity (i.e., thousands of participants or extremely frequent participation is required).

Combined, these factors limit the ability of traditional markets to overcome a limited liquidity and operate efficiently in determining a crowd prediction of likelihood. Improved guidance as to the most likely outcome for a particular uncertainty in business environments where liquidity is not met, such as those faced in high-tech business environments (e.g., pharmaceutical drug development process), would greatly assist portfolio management and improve the efficiency of investments. Thus, modifications to the traditional market structure are needed to create prediction markets that elicit more accurate predictions surrounding business decisions.

U.S. Patent Application Publication US 2007/0250429A1, published Oct. 25, 2007, discloses a method of using a prediction market to determine a probability of a pharmaceutical product candidate meeting clinical trial goals.

### SUMMARY OF THE INVENTION

The present invention provides a prediction market for predicting relative probabilities of different possible outcomes occurring for situations where there is little or no market liquidity. More particularly, the present invention is directed to a computer-implemented method for generating a prediction market data output (e.g., a graph, tabular display). The prediction market generated by the disclosed method can be used to help make business decisions, especially business decisions in high-tech and highly-regulated industries, that are greatly impacted by the outcome of projects having uncertain timelines and/or uncertain results. In this new market structure, the principle of market efficiency is leveraged, and the markets are allowed to efficiently determine the “fair” price that participants were willing to pay for a stake in a predicted outcome. This is done by managing the pace of the markets.

The present invention relates to a computer-implemented method for generating a prediction market data output to gauge relative probabilities of potential outcomes for an event occurring in the future. An “event,” as used herein, may represent a particular business or technical milestone, goal or objective associated with a business or technical project or process with an uncertain timeline and/or uncertain result.

The method generally includes first providing to a target group of participants a question (also referred to as a “market”) that assesses the outcome of an event, a fixed number of answer choices representing potential outcomes of the event, and a fixed number of weight points. Only one of said answer choices can be the actual outcome of the event, and that answer choice is determined to be the actual outcome when resolution of the event occurs. Each participant of the target group has relevant knowledge related to the subject matter of the event, and the target group is cognitively diverse regarding the subject matter of the event. Two or more participants allocate the fixed number of weight points across the answer choices (representing the first prediction period), and the predicted odds for choosing a particular answer choice in the first prediction period is calculated based on comparing the sum total weight points allocated to each answer choice to the sum total weight points allocated across the participants' predictions. On a periodic basis after the first prediction period, the same target group of participants is provided the same question and answer choices, the same fixed number of weight points, and the predicted odds for choosing a particular answer choice as calculated from the summed predictions of the previous period. Again, two or more participants allocate the fixed number of weight points across the answer choices; and, for each subsequent prediction period, the predicted odds for choosing a particular answer choice are calculated. The prediction market represents the relative probabilities of the potential outcomes for the event across the prediction periods (the market length). The predicted odds for each answer choice per prediction period over the length of time in which predictions are received (the market length) can be displayed in some form of data output (e.g., graph, table). The present invention relates to computer-implemented methods of generating a prediction market output and apparatus to implement said method.

One project may have many different milestones or goals that represent individual business or technical objectives of the project. Thus, a separate question/market may be provided to the same target group of participants for each milestone or goal of the project. Calculating the relative probabilities across the potential outcomes over the market length for each question represents a separate prediction market, generating a separate prediction market data output.

The objectives of the method of generating a prediction market described in the present invention include the following: (a) to negate reliance of market functioning on liquidity (driven by changing information, participation, and diversity of participant knowledge and perspective); (b) to ensure participation to maintain enough data points; (c) to make market manipulation unlikely; and, (d) to minimize the effect of risk aversion of participants.

To meet these objectives, certain modifications to traditional methods for generating prediction markets have been made, including the following: (a) eliminating trading platform and introducing a pari-mutuel input platform, such that trading opportunities did not limit participation; (b) identifying a target group of participants, wherein each participant of the target group has relevant knowledge of the subject matter of the project, and wherein there is cognitive diversity across the participant pool (i.e., not a random crowd of predictors); (c) introducing a defined, periodic basis for inputting predictions (e.g., weekly), such that the predicted probabilities of outcomes moved each week, not each moment, and predictions would be on a calendar basis, not dependent on new information; (d) issuing an equal number of weight points to each participant to allocate each week, negating the ability of a few participants to gain control of the markets (i.e., winnings increased, but input resources did not); (e) ensuring that individual predictions did not have the power to independently influence predicted odds; and, (f) incentivizing early accuracy to encourage focused participation. With these changes, the underlying principles required for accurately predicting the probabilities of outcomes were preserved: (a) others' predictions determined the odds at which one could buy a winning stake; and, (b) predicting the “right” outcome when it is a less popular prediction means higher winning margins.

The present invention also provides methods for using the prediction market generated as described herein. The disclosed invention can be used to facilitate decisions tied to projects with uncertain outcomes (e.g., projects with issues related to cycle time, cost and risk). In one embodiment, the disclosed invention can be used to facilitate decisions in the pharmaceutical industry. Business uncertainties in the pharmaceutical sector may involve assessing clinical and/or other outcomes for potential products that require the successful conclusion of regulatory trials to gain marketing authorization, including medicines (e.g., biotechnological, chemical, or vaccine medicinal products) and medical devices (e.g., diagnostic tests). The disclosed invention can also be used when evaluating in-licensing opportunities, to identify potential stock market mis-pricing of publicly-traded equities of pharmaceutical and medical device companies, and to generate competitive intelligence by estimating the competitive position of a pharmaceutical product or product candidate in development.

The exemplary embodiments described in this application can be implemented in any suitable form, including hardware, software, firmware or any combination thereof. The present invention relates to a method for generating a prediction market output display using a prediction market computer system comprising a user interface, a probability calculator module, a data output module (e.g., a graphing module) and a database. Different aspects of the exemplary embodiments may be implemented, at least partly, as computer software or firmware running on one or more data processors and/or digital signal processors. Thus, the elements and components of a particular exemplary embodiment may be physically, functionally and logically implemented in any suitable way. Indeed the functionality may be implemented in a single unit, in a plurality of units or as part of other functional units. Thus, the present invention also provides an apparatus having executable instructions for generating a prediction market data output as described.

### BRIEF DESCRIPTION OF THE DRAWINGS

FIG. 1 shows a prediction market graph for a market/question of Example 2. The question concerned when and whether a second quarter (Q2) milestone to determine if a gene expression signature would be qualified as a target engagement biomarker for a product candidate. The probability for predicting one of the 5 possible answer choices is shown on the y axis over an eight week period (from May 10 to June 28), shown on the x axis. From May 24 to May 31, there were rumors that the milestone was about to be reached and the signature qualified. The results show that the market drastically shifted predictions to adjust for the new information.

FIG. 2 shows a prediction market graph for a market/question of Example 2. The question posed concerned the results of a clinical trial that were to be presented at a scientific conference. The clinical trial was designed to test the effect of a marketed drug on a new indication. The probability for predicting one of the 4 possible answer choices is shown on the y axis over an 6 week period (from May 10 to June 14), shown on the x axis. It was found that 75-84% of cumulative predictions predicted that the effect of the drug would be positive. The overwhelming sentiment of the crowd correctly hypothesized the directionality of the result presented at the conference.

FIG. 3 shows a prediction market graph for a market/question of Example 2. The question posed concerned when/if a proof of biology study for a product candidate would be resolved. “Resolution” was dependent on determining that proof of biology was either achieved or not achieved. The probability for predicting one of the 3 possible answer choices is shown on the y axis over an eight week period (shown on the x axis). Although the market did not reveal an overwhelming crowd sentiment or shift regarding outcome, it seemed to reveal a strong sentiment on the timeline of resolution. The implication is that prediction markets can potentially help an organization isolate timeline uncertainty from technical uncertainty, which can aid in planning.

FIG. 4 shows a high-level block diagram illustrating an exemplary computer system 401 for generating a prediction market according to one embodiment of the present invention.

FIG. 5 shows a flow diagram illustrating by way of example the steps that may be performed for creating a prediction market according to one embodiment of the present invention.

### DETAILED DESCRIPTION OF THE INVENTION

The methods described in the present application relate to computer-implemented methods for generating a prediction market data output of relative probabilities for choosing a particular answer choice for a question that relates to an event occurring in the future. The event may represent a particular business or technical milestone, goal or objective associated with a business or technical project or process with an uncertain timeline and/or uncertain result. A prediction market generated by the disclosed methods can be used to prioritize between multiple programs/projects, rank ordering them by assigning quantitative values (via the “odds”) to the probability of success in meeting certain milestones or goals related to the projects. Prediction markets generated by the methods of the present invention also offer a solution to the problem of determining valuation and/or creating a strategic long-range plan to guide investment and portfolio management for a company.

Prediction markets generated by the methods described herein can be used in any research and development-intensive industry, including for example energy, high tech, automotive, aerospace, pharmaceutical and agriculture industries, as well as in businesses developing new financial products (e.g., banks, insurers), wherein the core business and/or the specific project in question involves cycle time, technical and/or regulatory risks, and/or uncertainties regarding the future of new products and/or portions thereof. For example, the prediction market of the present invention can be used to predict an outcome related to the availability of a natural resource. Thus, the project with the business uncertainty, as described herein, may relate to natural gas discovery in a certain geographic location. Prediction markets generated by the disclosed method can also be used by institutions that assess the value of projects related to these industries/businesses (e.g., institutions in the financial sector). For example, the prediction market as described can be used by the agriculture industry and supporting financial institutions to predict prices of grains.

### A. Method and Apparatus for Generating a Prediction Market

In one embodiment, the present invention relates to a method for generating a prediction market data output of relative probabilities for choosing a particular answer choice for a question related to an event occurring in the future using a prediction market computer system comprising a user interface, a probability calculator module, a data output module and a database, the method comprising:

(a) receiving in a first prediction period via the user interface a first prediction input from each of two or more participants of a target group, wherein the first prediction input comprises a participant's allocation of a fixed number of weight points across fixed answer choices for the question, wherein the answer choices represent potential outcomes for the event, and wherein only one of said fixed answer choices can be an actual outcome for said event;

(b) recording each of said first prediction inputs in the database;

(c) executing the probability calculator module to calculate a response ratio for each answer choice, wherein the response ratio is a predicted odds for choosing a particular answer choice based on comparing sum total weight points allocated to each answer choice in the first prediction period to sum total weight points allocated in the first prediction period;

(d) receiving in a subsequent prediction period via the user interface a subsequent prediction input from each of two or more participants of the target group, wherein:
(i) subsequent prediction periods occur on a periodic basis after the first prediction period;
(ii) each subsequent prediction input comprises a participant's allocation of a fixed number of weight points across fixed answer choices;
(iii) the fixed number of weight points and the fixed answer choices are the same as in the first prediction period; and,
(iv) each participant is provided the response ratio for each answer choice calculated in the previous prediction period prior to allocating the weight points;

(e) recording each of said subsequent prediction inputs in the database;

(f) executing the probability calculator module to calculate for each subsequent prediction period the response ratio for each answer choice in said subsequent prediction period, wherein the response ratio is the predicted odds for choosing a particular answer choice based on comparing sum total of weight points allocated to each answer choice in said subsequent prediction period to sum total number of weight points allocated in said subsequent prediction period;

(g) repeating steps (d)-(f) either until a point in time either prior to or until the actual outcome for said event occurs, wherein market length is set when prediction inputs cease; and,

(h) executing the data output module to display the response ratio for each answer choice per prediction period over the market length, generating the prediction market data output.

In a further embodiment, the user interface of the prediction market computer system is configured to display on a display screen of a human output device of each participant of the target group the question, the fixed answer choices, the fixed number of weight points, and optionally the response ratio for each answer choice as calculated from the previous prediction period. The response ratio for each answer choice that was calculated from the previous prediction period is displayed during each prediction period after the first prediction period (i.e., in all subsequent prediction periods after the first prediction period). The previous prediction period is the prediction period immediately prior to the prediction period in which a participant is requested to submit a prediction.

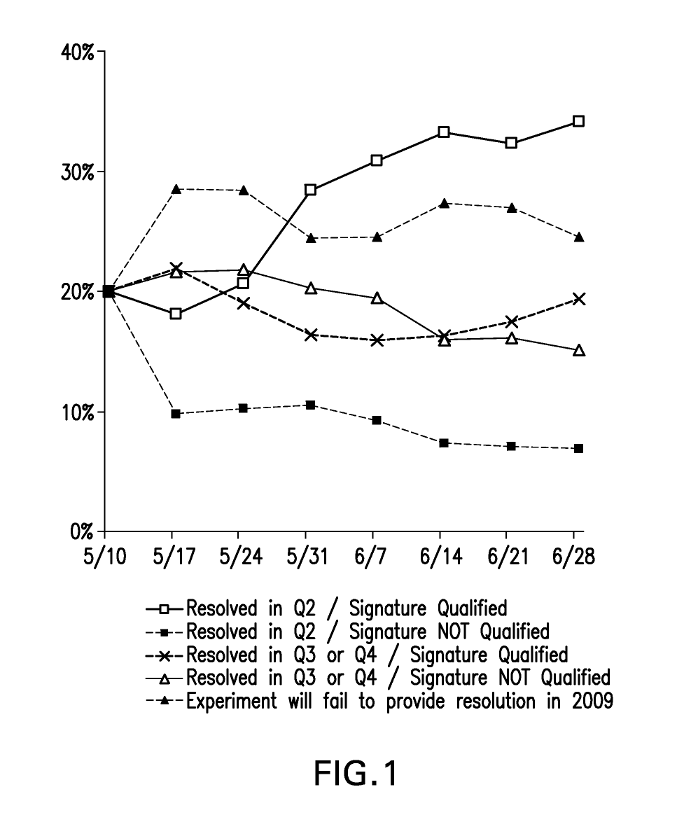

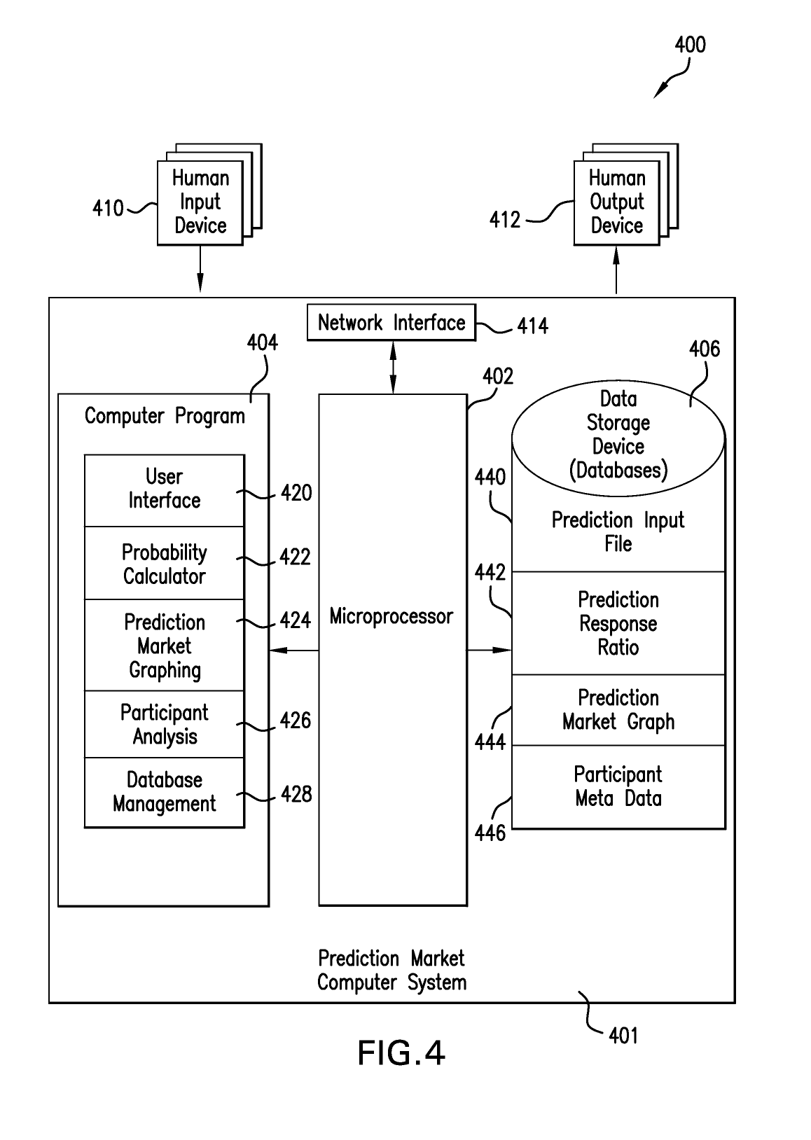

The data output module is a module comprises program instructions that, when executed by the microprocessor, causes the microprocessor to display the relative probabilities for choosing each answer choice across all or a portion of the market length. The display of the data can take any form, including but not limited to a graph or a table. In one embodiment, the prediction market data is displayed as a graph, for example wherein time is measured on the x axis and probability for predicting one or more of the answer choices is measured on the y axis (e.g., FIG. 1). In this embodiment, the data output module is a graphing module (e.g., see FIG. 4). In another embodiment, the prediction market data is displayed as a tabulating module. In a further embodiment, a prediction market computer system of the invention may contain a data output module that comprises the ability to display the prediction market data output in multiple formats (e.g., in a graphical format, a tabular format, or another format). The prediction market output can be displayed on a computer device, e.g., for viewing on a monitor, storage within a data storage device, or printing.

FIG. 4 shows a detailed view of a prediction market computer system 401, arranged to operate in accordance with the present invention, and the associated computer networked environment 400. As shown in FIG. 4, the prediction market computer system 401 includes a microprocessor 402, a computer program 404 comprising one or more of a collection of software modules 420, 422, 424, 426 and 428, a network interface 414, and a data storage device 406, which comprises a one or more files and/or databases 440, 442, 444 and 446. The prediction market computer system can be any general purpose, programmable digital computing device, including, for example a personal computer, a programmable logic controller, a distributed control system, or other computing device. The computer system can include a central processing unit (CPU) containing a microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). The network interface 414 and the data storage device 406 may be integrated into the same physical machine as the microprocessor 402 and one or more of the computer program software modules 420, 422, 424, 426 and 428, as shown in FIG. 4, but some or all of these components may also reside on separate computer systems in a distributed arrangement without departing from the scope of the claimed invention. Program code, such as the code comprising the computer program 404, can be loaded into the RAM from the non-volatile secondary storage and provided to the microprocessor 402 for execution. The microprocessor 402 can generate and store results on the data storage device 406 for subsequent access, display, output and/or transmission to other computer systems and computer programs.

The computer networked environment 400 includes a plurality of human input devices 410 and a plurality of human output devices 412 connected to the prediction market computer system 401 that may operate under the control of a user interface module 420 in the computer program 404. The human input devices 410 and human output devices 412 may comprise a combination of personal computers, notebooks, pad or handheld computers, Internet-enabled smart phones or digital assistants. A participant's prediction input may be transmitted to the prediction market computer system 401 using a human input device 410, and a request to participate in a market may be displayed on the display screen of a participant's human output device 412. As the results of the prediction inputs are recorded on the data storage device 406, those results can be viewed, navigated and modified, as required, by other human users interacting with the prediction market computer system 401 via other human input devices 410 and human output devices 412. A network interface 414, under the operation of a user interface module 420, provides connectivity to establish a connection between the prediction market computer system 401 and the human input devices 410 and human output devices 412.

The computer program 404, which may comprise multiple hardware or software modules, discussed hereinafter, contains program instructions that cause the microprocessor 402 to perform a variety of specific tasks required to extract, parse, index, tag, store and report prediction input data contained in the data storage device 406. Each module may comprise a computer software program, procedures, or processes written as source code in a conventional programming language, and can be presented for execution by the CPU microprocessor 402. The various implementations of the source code and object and byte codes can be stored on a computer-readable storage medium (such as a DVD, CD-ROM, floppy disk or memory card) or embodied on a transmission medium or carrier wave. The program modules of the computer program 404 may include a user interface module 420, a probability calculator module 422, a data output module, such as graphing module 424, a participant analysis module 425 and/or a database management module 428. The graphing module 424 is an example for purposes of illustrating a data output module that may be comprised within computer program 404 to display the prediction market data output. In another embodiment, one or mote of the program modules shown in the computer program 404 can be presented for execution by the CPU of a network server in a distributed computer scheme.

The data storage device 406 may comprise one or more separate data storage devices or may be implemented in a single storage device having a plurality of files or a plurality of segmented memory tables operating under the control of a database management system, but which may be incorporated into the data storage component 406 or which may be a separate processor. The data storage device 406 may house a prediction input file database 440 for storing individual participant prediction input data. The prediction input file can be in the form of a text file. The prediction input file may have a unique file identifier, which may be saved in a document ID file of the prediction input file database 440. The document ID file may also include file attributes, such as the participant name and various additional descriptors (e.g., employment history, current employer, educational background, age). The data storage device 406 may further comprise a prediction response ratio database 424 for storing the calculated response ratio for selecting a particular answer choice based upon the allocation of the weight points distributed across the answer choices from a prediction period, a prediction market data output database, such as a graph database 444, for storing prediction market data compiled across the market length (e.g., graphing the relative probabilities of the potential outcomes for the event), and a participant meta data database 446 for tagged participant data associated with previous prediction markets (e.g., participants that consistently predicted the actual outcome).

In one embodiment of the invention, the computer program 404 comprises a user interface module 422, which comprises program instructions that, when executed by the microprocessor 402, causes the microprocessor 402 to provide content to a human output device 412 or to process input received from a human input device 410. The user interface module 422 can be executed via the network interface 414 to transfer data content (either output or input) with a remote user device, e.g., enabling the display of information on a remote participant computer. Alternatively, the user interface module 422 can be executed to enable direct data transfer with input and output devices directly connected with the computer system, e.g., display monitor, printer, speaker, keyboard, pointing device and/or touch screen. The user interface module 422 may also enable a user to view and navigate the prediction data stored in the data storage device 406. For example, a user may use a human input device 410 to perform operations to manipulate the information stored in the data storage device 406. A human output device 412 can provide a display or printout showing the details of the market question and answer choices.

In another embodiment of the invention, the computer program 404 comprises a probability calculator module 422, which comprises program instructions that, when executed by the microprocessor 402, causes the microprocessor 402 to read prediction input files stored within the data storage device 406, e.g., within the prediction input file database 440, and calculate a participant response ratio for each answer choice in the prediction period. The response ratio is based upon the sum total of weight points allocated to each answer choice in a prediction period compared to the sum total of weight points allocated in the prediction period. The probability calculator module 422 calculates from the prediction input files of a prediction period the sum total participant response for each answer choice based on weight point allocation (i.e., calculates the total number of weight points distributed to each answer choice in a prediction period) and the sum total of weight points allocated in the prediction period. The predicted odds ratio for each answer choice is then calculated.

An algorithm can be used to calculate the odds for choosing a particular answer choice per prediction period. For example, suppose a market question has 5 possible answer choices. If 100 prediction inputs are received in a prediction period (i.e., representing predictions from 100 participants), and each participant allocated 10 weight points across the 5 answer choices, 1000 weight points are available for this market (100 prediction inputs x 10 weight points per input). If all 100 prediction inputs have 10 weight points allocated across the 5 answer choices, and one of the answer choices has a total of 500 weight points (sum of all weight points within the 100 prediction inputs allocated to that particular answer choice), the predicted odds for that particular answer choice in that prediction period is 1000:500 (2:1). Similarly, if another answer choice has a total of 200 weight points allocated across the 100 prediction inputs, the predicted odds for that outcome is 5:1. Thus, when predicting the odds associated with each answer choice, the relative probability across the answer choices is determined. Prediction response ratio data files can be stored within the data storage device 406, e.g., in a prediction response ratio database 444.

In another embodiment of the invention, the computer program 404 may comprise a prediction market graphing module 424, which comprises program instructions that, when executed by the microprocessor 402, causes the microprocessor 402 to extract the data from the data storage device 406, e.g., from the prediction response ratio database 442, and to graph the relative probabilities for choosing each answer choice across all or a portion of the market length. There are many commercially available graphing programs (e.g., SigmaPlot graphing software from Systat Software) that can be used. Prediction market graph data files can be stored within the data storage device 406, e.g., in a prediction market graph database 444. The graphing module 424 represents one of many different data output modules that may be used to compile and display the prediction market data. The present invention is not limited to only displaying the prediction market data in a graphical display. Thus, for example, computer program 404 may comprise a different data output module (e.g., a tabulating module) or a data output module with the ability to display the data in many different formats.

In a further embodiment of the invention, the computer program 404 may comprise a participant analysis module 426, which comprises program instructions that, when executed by the microprocessor 402, causes the microprocessor 402 to extract and tag participant data from previous prediction markets, parsing the data into subsets of participants that, for example, may be later utilized to participate in generating prediction markets related to a similar subject matter (e.g., participants who consistently predicted the actual outcome). The participant meta data may be stored within the data storage device 406, e.g., in a participant meta data database 446.

The computer program 404 may include a database management module 428 that organizes files and facilitates storing and retrieving files to and from various databases within the data storage device 406. Any type of database organization can be utilized, including a flat file system, hierarchical database, relational database, or distributed database. A database management module 428 assists the microprocessor 402 to retrieve, modify, and restore data in the data storage device 406.

In one embodiment, communication between the target group participants using a human input device 410 and human output device 412 and the prediction market computer system 401 occurs over the Internet. In general, transfer of information on the Internet will occur between a client terminal and a server and will often utilize hypertext transfer protocol (HTTP). This protocol permits client systems connected to the Internet to access independent and geographically scattered server systems to also connect to the Internet. Participant side browsers, such as Mozilla's Firefox and Microsoft's Internet Explorer provide efficient graphical user interface based applications that implement the client side portion of the HTTP protocol. Server side application programs including the services provided by the network interface 414, implement the server side of the HTTP protocol. HTTP server applications are widely available. The distributed system of communication and information transfer made possible by the HTTP protocol is commonly known as the World Wide Web (WWW).

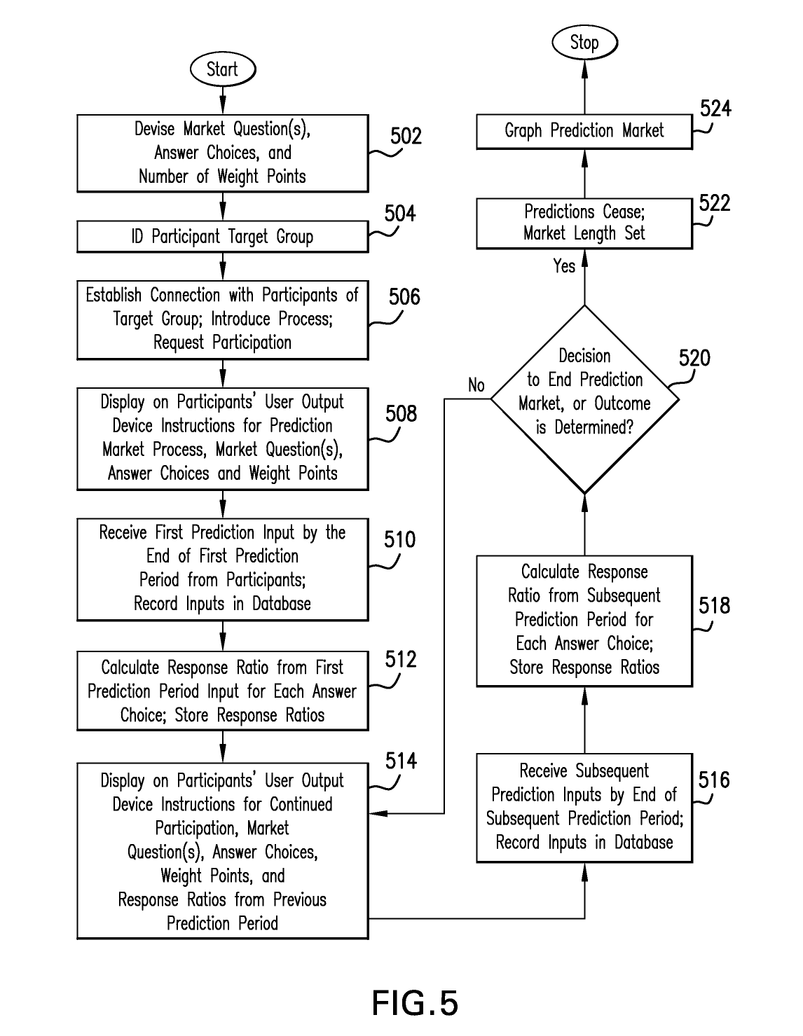

FIG. 5 shows a flow diagram illustrating, by way of example, the steps that may be implemented in accordance with certain embodiments of the present invention, including steps that are implemented within a computer system, such as the prediction market computer system 401 shown in FIG. 4, to generate a prediction market data output of relative probabilities for potential outcomes for an event. The majority of the procedure may be implemented as a conventional software program comprising a plurality of functional modules, each have program instructions for execution by a microprocessor, or it may be implemented by another suitable device.

As illustrated in FIG. 5, the procedure begins with step 502, wherein one or more market questions and answer choices are devised that assess the potential outcomes of a particular event of interest. This step is performed by one or more individuals with interest in generating a prediction market on that particular subject matter. In another embodiment, the market question(s) and answer choices may be devised in conjunction or collaboration with one or more third parties designated to assist with implementing the prediction market process. Once the question(s) and answers have been devised, a target group of participants is identified, wherein each participant has relevant knowledge related to the subject matter of the project (step 504). The target group is also cognitively diverse regarding the subject matter of the project to which the question is related. The target group of participants can be identified either by the same individuals and/or third parties who participated in devising the market question(s) and answer choices, or by others. The number of weight points to assign a particular prediction market process can be assigned either by the same individual(s) who devised the market question(s)/answer choices or by one or more third parties designated to assist with the implementation of the prediction market process, or in collaboration.

The remaining steps of the flow diagram are implemented on a computer system, such as the prediction market computer system 401 illustrated in FIG. 4. In step 506, the computer system establishes a connection to a human output device of each participant of the identified target group. Typically, this connection comprises a wired or wireless communication link over a local or wide area network, such as the Internet, via a network interface, such as network interface 414 in FIG. 4. At the time of establishing this connection, an introduction to the process for participating in the prediction market is displayed on a display screen of the participants' human output devices, along with an invitation or request for participation. Once connections with participant human output devices are established, and an invitation has been displayed thereon, step 508 includes displaying on a display screen of each of the participants' human output devices the devised question, answer choices and weight points that were devised in step 502. Detailed instructions of how to participate in the prediction market process (e.g., how to submit prediction inputs, the length of the prediction period) are also displayed.

In step 510, first prediction inputs are received by the computer system, such as prediction market computer system 401 of FIG. 4, before the end of a pre-assigned prediction period (i.e., the first prediction period). The first prediction inputs are submitted by participants from the target group using individual human input devices. A prediction input data can be received by the computer system in the form of a text file. The prediction input data is then recorded in a data storage device, such as data storage device 406 of FIG. 4 (e.g., within the prediction input file database 440). A prediction input represents a participant's allocation of the available weight points among the answer choices of the market question.

In step 512, for each answer choice for a given market in the first prediction period, a participant response ratio is calculated by, for example, a probability calculator module of a computer program within the computer system, such as probability calculator module 422 within computer program 404 of FIG. 4. The response ratio is determined by comparing the total number of weight points allocated to each answer choice in the first prediction inputs to the total number of weight points allocated in the first prediction period, representing the predicted odds ratio for choosing a particular answer choice. The computer program may contain program instructions to first compile (i.e., sum) the data from each first prediction input file received/recorded and then calculate the response ratio for each answer choice from said compiled data. The response ratio data can be stored in a data storage device, such as data storage device 406 of FIG. 4 (e.g., within the prediction response ratio database 442).

In step 514, at the beginning of the next (subsequent) prediction period, as determined when the prediction market process was initially devised (step 502), the same market question(s), answer choices, and number of weight points are displayed on a human output device of each participant of the target group, as well as the response ratio for each answer choice as calculated from the previous prediction period (step 512). In step 516, prediction inputs from the subsequent prediction period are then submitted by each of at least two or more participants of the target group prior to the end of the subsequent prediction period and received by a computer system, such as prediction market computer system 401 of FIG. 4. Similar to step 510, the subsequent prediction inputs can be received by the computer system in the form of a text file. The subsequent prediction input data is stored in a data storage device, such as data storage device 406 of FIG. 4. Each subsequent prediction input represents a participant's allocation of the available weight points among the answer choices of the market question in the subsequent prediction period. The subsequent prediction input data is then compiled (i.e., the weight points per answer choice summed and the total weight points summed), and response ratios representing the predicted odds ratio for choosing a particular answer choice is calculated (see step 518).

After receiving and analyzing the subsequent prediction inputs, it is then determined whether or not to continue requesting prediction inputs from the target. This decision is represented by step 520 in FIG. 5. At the point in time when a decision is made to stop requesting prediction inputs for a particular market, or when the outcome for the event is determined, requests for subsequent prediction inputs cease. When prediction inputs cease, market length is set (step 522). The market length is the span of time from receiving the first prediction inputs to receiving the last prediction inputs. If the decision is made to continue requesting prediction inputs and/or the outcome of the event has not occurred, steps 514-520 are repeated until such time when the predictions cease and the market length is set. In one embodiment, the decision regarding the point in time by which to stop requesting predictions can be programmed into the computer program. For example, a request to submit predictions may continue until a point in time when the relative probability of one answer choice reaches a threshold percent value across a certain number of sequential prediction periods. As another example, a request to submit predictions may continue until a point in time when the cumulative probability of a few, similar-trended answer choices reaches a threshold percent value across a certain number of sequential prediction periods. Alternatively, a request to submit predictions may continue until a point in time when a third party individual instructs the computer system to end the prediction market, discontinuing the request to submit prediction inputs. The prediction inputs may also cease when outcome of the event is resolved.

In step 524, the resulting prediction market data is compiled and displayed in some form of output format—e.g., a graph, wherein the predicted odds ratio for choosing each answer choice is graphed across all or a portion of the market length. A prediction market data output display program (e.g., a graphing software program) can be executed to generate an output of the resulting prediction market, such as prediction market graphing module 424 within computer program 404 of FIG. 4. Graphing module 424 extracts the predicted odds ratio data from a data storage device and graphs the odds ratios over the market length. The prediction market graph can be stored in a data storage device, such data storage device 406 of FIG. 4 (e.g., within the prediction market database 444).

The present invention further relates to an apparatus for generating a prediction market data output of relative probabilities for choosing a particular answer choice for a question related to an event occurring in the future. The apparatus comprises the following components:

(i) a microprocessor;

(ii) a user interface module comprising program instructions that, when executed by the microprocessor, enables display via a network interface on a display screen of a human output device of each participant of a target group on a periodic basis:
(1) the question;
(2) fixed answer choices representing potential outcomes for said event, wherein only one of said fixed answer choices can be an actual outcome for said event;
(3) a fixed number of weight points;
(4) a request and instructions to participate in a prediction market process, wherein said prediction market process comprises the participant submitting a prediction input on said periodic basis that is received and recorded by the apparatus, and wherein the prediction input comprises the participant's allocation of the weight points across the answer choices; and,
(5) for each prediction period after a first prediction period, a response ratio for each answer choice chosen in the previous prediction period, wherein a response ratio is a predicted odds for choosing a particular answer choice based on comparing sum total weight points allocated to each answer choice in a prediction period to sum total weight points allocated in a prediction period;

(iii) a probability calculator module comprising program instructions that, when executed by the microprocessor, calculates from the prediction inputs received in a single prediction period the response ratio for each answer choice in said single prediction period; and,

(iv) a prediction market data output module comprising program instructions that, when executed by the microprocessor, generates a display of the response ratio for each answer choice per prediction period over market length.

In one embodiment, the apparatus further comprises a data storage device that stores a plurality of prediction input data files and memory for storing said data files. When prediction inputs are received by a prediction market computer system, the data is recorded in said data storage device. The prediction inputs may be received in the form of a text file. The storage device may comprise more than one individual data storage databases.

In another embodiment, the apparatus further comprises a participant analysis module comprising program instructions that, when executed by a microprocessor, extracts and tags participant data stored with a data storage device, parsing the participant data into subsets of participants with a particular characteristic.

In a further embodiment, the apparatus further comprises a database management module comprising program instructions that, when executed by a microprocessor, organizes stored data files and facilitates storing and retrieving files to and from data storage device databases.

In one embodiment of the present invention, the prediction market generated by the described methods relates to a project having a “short term” milestone or goal that may be achievable within one year or less from the time of conceptualization of said milestone/goal. In another embodiment, the milestone or goal is a “long term” milestone or goal that may be achievable beyond one year from the time of conceptualization of said milestone/goal.

In another embodiment, the phrase “periodically” or “periodic basis,” as used in the present method of generating a prediction market data output and/or using the information obtained from said prediction market data output, refers to a frequency selected from the group consisting of: once every three days, once a week, once every two weeks, once every three weeks or once a month. In another embodiment, “periodically” or “periodic basis” refers to once per week; “previous period” refers to the previous week; and “each period” refers to each week. The question and answer choices are displayed on the human output device of each participant of a target group at the beginning of the “period.” For example, if “periodic basis” refers to once per week, the question and answer choices are displayed at the beginning of a week (i.e., 7 day period). In this scenario, a prediction input must be received from a participant's human input device within one week from the question and answer choices being displayed on the participant's human output device. In this example, if a prediction input is received on day 2 of the period, and yet on day 3 the participant learns of new information relevant to the question/market, a revised prediction input may be received, changing the original prediction for the period, up until the prediction period closes at the end of the week.

In a further embodiment, the fixed number of weight points per question/market displayed to each participant of a target group requested to provide a prediction input by the method described in the present application is selected from a group consisting of one (1) weight point, a number that allows equal distribution of weight points across the answer choices, and a number that is greater than 1 and forces an unequal distribution of weight points across the answer choices. In a preferred embodiment, the fixed number of weight points per question/market is a number greater than one and forces an unequal distribution of weight points across the answer choices (i.e., creating an asymmetric distribution of tokens across the answer choices). For example, if there are 5 answer choices and 10 weight points are provided to distribute across the answer choices, assuming that a participant uses all of the weight points provided when making a prediction, it is possible for 2 weight points to be distributed evenly across the 5 answer choices. However, if 12 weight points are provided to be distributed across 5 answer choices, it is not possible to have an even distribution of weight points across each answer choice. This represents an asymmetric distribution of weight points.

The prediction market data output generated by the methods of the present invention represents the relative probabilities of potential outcomes for an event occurring in the future across the span of time in which prediction inputs are received (i.e., across the market length). Thus, the prediction market represents the kinetics of the relative probabilities of the potential outcomes selected by the participants across the market length.

In one embodiment, the market length is any span of time from when the first prediction input is received up to (i.e., prior to) the point in time when resolution of the event occurs and the actual outcome is known to the target group of participants. As an example, prediction inputs may be requested until a point in time, prior to the resolution of the event, wherein the relative probability of one answer choice (i.e., one potential outcome) reaches a threshold percent value across a certain number of sequential prediction periods. As another example, predictions inputs may be requested until a point in time, prior to the resolution of the event, wherein the cumulative probability of a few, similar-trended answer choices reaches a threshold percent value across a certain number of sequential prediction periods. Once that point in time occurs, the market length is set and further predictions are no longer requested of the target group. Thus, the market length may be set once the sentiment of the participants is shown to be consistent.

In another embodiment, the market length is the span of time from when the first prediction input is received up until and including the point in time when resolution of the milestone/goal occurs and is known to the target group of participants. For example, if the sentiment of the participants is not determined to be overwhelming in favor of one potential outcome, it may be beneficial to continue to receive predictions from the target group until the resolution of the event occurs. The individual predictions may be analyzed, after the event is resolved, to determine whether a subset of the participants can be identified who consistently predicted the actual outcome. It is this “wise crowd” of individuals who may be later utilized to participate in the generation of prediction markets related to similar events (e.g., in a subject area with similar business or technical objectives).

The methods of generating a prediction market data output as described in the present invention comprise displaying questions, answer choices and weight points via a user interface on a display screen of a human output device of each participant of a target group. The target group is comprised of individuals with some knowledge of the subject area related to an event (e.g., a project with business uncertainty), rather than a completely random group of individuals. While the degree of knowledge of the subject area related to the event can vary, the key to selecting the target group of participants is ensuring that the group as a whole is cognitively diverse.

As used herein, a target group of participants having cognitive diversity is a group of people wherein the knowledge base of the group ranges from individuals with no specific knowledge of an event that is to occur in the future (e.g., a project's objective) to individuals who are considered experts in the subject area related to the event and/or have specific knowledge of the event (e.g., of the project). Thus, each individual in the target group of participants has some knowledge of the subject matter to which the event pertains. Since the participants are not randomly selected, but rather have knowledge of the subject matter of the event, cognitive diversity among the participants of the target group is crucial so that individuals with specific ties event in question are not overrepresented. This is because decision-making bias is pervasive, especially in intensive, product R&D industries. For example, project leaders and members of product development teams are vulnerable to advocating for their project. If the participant pool only consists of members of product development teams, or if members of these teams are overrepresented in the participant pool, the prediction output would be skewed to positive outcomes (e.g., enabled by market manipulation). By polling a cognitively diverse target group of participants, the prediction market generated by the methods disclosed is based on the “wisdom-of-the-knowledgeable crowd,” rather that the “wisdom-of-the-crowd,” leveraging the latent knowledge across the individuals of a particular corporation or in a particular industry.

As an example, a cognitively diverse target group of participants may include individuals who are considered to be knowledge experts with regard to the project and/or objective that is the subject of the event (e.g., those with intimate knowledge of the project and/or objective, such as project managers and project team members, immediate stakeholders of the project/objective, and the like), individuals with general knowledge of the field and/or subject area (e.g., journalists, financial traders, patent attorneys at a company that owns or controls the project with the business uncertainty), subject-matter experts in the field and/or subject area generally related to the project (e.g., noted academicians in the field), and individuals with little or no specific knowledge of the project (e.g., administrative support staff at a company that owns or controls the project with the business uncertainty). In each case, the individuals have relevant knowledge of the subject matter of the project with the uncertain outcome. The particular type of knowledge desired in the participants will depend on the parameter for which the probability of success in achieving the timeline and/or result is being measured.

For prediction markets related to a project in the pharmaceutical area, a target group of participants may include, but is not limited to, employees of a pharmaceutical company that owns or controls the project with the business uncertainty, including but not limited to those with knowledge of the drug discovery process, clinical development, pharmaceutical marketing, and patenting of pharmaceuticals. Participants may also include key opinion leaders, such as published and referenced contributors to relevant literature, in at least one of the following subjects: pharmaceutical, diagnostic, medical device or vaccine development; a therapeutic area (e.g., cancer) and/or a subset of a broad therapeutic area (e.g., pancreatic cancer, or solid tumors); a molecule or pathway modulated by a given product or product candidate; drug manufacturing processes; pharmaceutical regulatory filing processes, including evaluating regulatory filings; and, biostatistics and mathematics related to pharmaceutical clinical development. For example, if the prediction market relates to a milestone or goal in the development of a pharmaceutical product candidate, participants may include individuals with intimate knowledge of the preclinical and/or clinical studies associated with the product candidate, and individuals knowledgeable about the biological features modulated by the product candidate, such as the biological target, pathway, cell type, or organ system affected by the product candidate. If the prediction market is used to estimate the probability of success of the outcome of a clinical trial, the group of participants may further include individuals knowledgeable about clinical trial design and the actions of the relevant administrative/regulatory organization, such as FDA. If the prediction market is used to estimate the probability of success of a product candidate meeting certain manufacturing deadlines, the target group of participants may further include individuals knowledgeable about pharmaceutical manufacturing processes, including individuals with intimate knowledge of the manufacturing of the product candidate.

In an embodiment of the method of the invention, each prediction input data file includes a unique identifier, which may be saved as a separate document ID file within a computer storage device. That document ID file may contain additional data file attributes, including for example information about the participant, such as name, current employer, current job responsibilities, employment history, affiliated organizations and educational background. This data may be analyzed (e.g., parsed and/or tagged) at a later point to group the individual predictors into subsets of participants with a particular characteristic. For example, the data may be analyzed to identify and group individual predictors having a certain type of cognitive diversity or a good track record in predicting the actual outcome of milestones/goals in related subject areas (e.g., in subject areas with similar business or technical objectives having uncertain timelines and/or results). As an example, in one embodiment of the present invention, participant analysis module 426 of computer program 404 may be executed to meta-tag the participant data, providing the opportunity to further refine the analysis of the data sets to help identify interesting patterns and drivers.

In another embodiment, a target group of participants represents a cognitively diverse “wise crowd,” wherein each of the participants in the crowd is a subject matter expert in an area or discipline related to the business uncertainty in question and/or has previously demonstrated to consistently predict the actual outcome in prediction markets, generated by the methods described in this application, related to a similar milestone/goal as that being assessed (e.g., in a subject area with similar business or technical objectives having uncertain timelines and/or results). The knowledge base of the “wise crowd” target group is elevated, yet still diverse such that it includes individuals from different disciplines that are generally involved in or knowledgeable about making decisions similar to those related to the milestone/goal at hand.

While a target group of individuals with knowledge of the subject area related to the event is preferred for the disclosed method of generating a prediction market data output, a control group of individuals having either no specific knowledge of the subject matter of the event, or a random group of individuals, can also be polled. In this scenario, the prediction market data output generated by receiving prediction inputs from the knowledgeable participants would be considered the “experimental prediction market,” while the other prediction market the “control prediction market.”

The number of prediction inputs received and recorded during each prediction period may either vary or remain constant across the market length (i.e., the number of participants from the target group in each prediction period who submit predictions may vary or remain constant across the market length). To help ensure that the number of prediction inputs received/recorded per prediction period increases or is maintained across the market length, the prediction market process includes an incentive scheme that may be displayed to the each participant of the target group. In one embodiment, the incentive is a reward given to those participants who participate in allocating weight points beyond a certain threshold number of periods (i.e., a participation reward). For example, a reward may be given if a participant submits predictions in at least approximately 20%, 30%, 40%, 50%, 60%, 70%, 80%, 90% or more of the prediction periods across the market length. Alternatively, the incentive is a reward given after the resolution of the market to those participants who allocated their weight points so as to most accurately predict the actual outcome of the event (i.e., a prediction reward). In either the participation or prediction reward structures, the reward can be a monetary reward (e.g., cash, securities, coupons, lottery tickets, discounts, credits, purchase rights, ownership rights, and the like) of a flat amount (e.g., $50, $100, $1000 or any practical amount or value deemed appropriate).

In a prediction reward structure, as an example, the amount of the monetary award can be based on the odds that result from the prediction inputs of the final prediction period. Alternatively, once an event has occurred and the market is therefore resolved (i.e., an outcome is determined), the amount of the monetary reward can be distributed according to the odds that resulted from each prediction period. For example, if the market length is 7 weeks long and the prediction period is weekly, the award for predicting the correct outcome (i.e., choosing the ultimately accurate answer) will vary for each week of participation. If, in week one, 10% of a question's 1000 weight points is allocated to, ultimately, the accurate answer, weight points placed on that answer choice in that week are rewarded at a rate of 9:1. If however, in week five, 50% of the weight points are placed on the ultimate accurate answer, weight points placed on that answer choice in that week are rewarded at a rate of 1:1. Under this scheme, participants use the information available from the previous period's predictions, combined with new information they may have gained about the market project, to make their allocations. Further, participants consider the reward odds that correspond to each potential outcome, as indicated by the previous week's predictions. Thus, construction of the market creates an incentive to predict the correct outcome ahead of other participants, leading to a greater reward.

### B. Uses

A prediction market data output generated by the methods described in the present application can be used across business functions and in any industry segment, including but not limited to use in regulated healthcare businesses such as pharmaceuticals, biotechnology, medical devices, and diagnostics. For example, the prediction market data output and the information provided by said data output can be used to predict an outcome of a milestone/goal associated with the pharmaceutical R&D process.

Thus, in one embodiment, the methods of the present invention relate to predicting the outcome of a milestone/goal (an event) for a project associated with a commercial pharmaceutical product, such as a marketed drug, and/or a preclinical or clinical pharmaceutical product candidate (i.e., a pharmaceutical drug, including a prophylactic, therapeutic, or diagnostic product, or a medical device, in development that has not yet received marketing approval by the relevant regulatory agency of a particular country). The milestone/goal represents a specific business or technical objective of a project related to the pharmaceutical product or product candidate, wherein the project has an uncertain timeline and/or uncertain result. In the pharmaceutical industry, the present invention finds utility in a number of areas. Some of these non-limiting areas include:

(a) predicting cycle time on complex R&D projects, including but not limited to dates that molecules will achieve milestones (e.g., phase shift, recruitment targets, IND or NDA filings with FDA);

(b) predicting risk related to internal or external pharmaceutical molecules/drugs (e.g., probability of technical success (POS) or probability of technical and regulatory success (PTRS));

(c) predicting manufacturing risks or cycle times;

(d) predicting outcomes of biology or chemistry experiments (e.g., experimental medicine trials, preclinical animal or in vitro results, biomarker assay results); and,

(e) using results from the prediction markets described in (a)-(d) above to predict stock market fluctuations in small companies impacted by significant events (e.g., a biotechnology company whose stock price is likely heavily predicated on success in a Phase II or III trial).

In regulated healthcare businesses that rely on clinical trials to achieve marketing authorization, the probability of success of a project in meeting its next milestone in a trial, or in simply being brought to the market, are important determinants of a project's expected net present value. Thus, in another embodiment of the invention, a question/market that assesses the outcome of an event relates to whether a commercial pharmaceutical product or preclinical or clinical product candidate (e.g., a chemical or biological molecule, vaccine, or medical device) achieves a clinical trial goal. The objective may have been publicly stated.

A clinical trial goal refers to any goal related to a pharmaceutical product or product candidate (e.g., a prophylactic or therapeutic agent, diagnostic test, or medical device) undergoing a clinical trial, such as primary or secondary endpoints of the clinical trial (e.g., a parameter that a clinical trial sets out to evaluate), clinical trial outcomes, trial timelines, and results of FDA interactions (e.g., product approved). For example, a clinical trial goal may include the following: whether the trial will achieve statistically significant performance against the trial's endpoint(s), as determined arithmetically as described in the trial's clinical protocol; the vote share of the relevant advisory committee members (number of yes votes, no votes, abstentions); the advisory committee voting outcomes (positive, equivocal (tie), negative); and, generation of FDA actions (e.g., letter of marketing approval, letter of approvable subject to various considerations, not approvable letter, other outcome).

Additional examples of a milestone or goal related to the development process of a pharmaceutical product of product candidate include, but are not limited, to the following: determining whether or not a clinical candidate achieves Proof of Biology (POB), Proof of Concept (PoC), Proof of Relevance (PoR), or any such similar designation, for a certain treatment indication, as well as the time required to make such a determination; determining whether a certain biomarker assay is effective for indicating usefulness of a preclinical/clinical candidate for a particular treatment indication, and the time required to make such determination; and, determining the effect of data or results of clinical trials relevant to the commercial product (e.g., Phase 4 post-marketing studies).

Proof of Concept (PoC) generally refers to a realization and/or demonstration of the feasibility of a certain method or idea, verifying that some concept or theory has the potential of being used. In the pharmaceutical area, PoC can refer to early clinical drug development, conventionally divided into Phase I and Phase IIa. Phase I is typically conducted in 10-20 healthy volunteers who are given single doses or short courses of treatment (e.g., up to 2 weeks). Studies in this Phase aim to show that the new drug has some of the desired clinical activity and can be tolerated when given to humans, and to give guidance as to dose levels that are worthy of further study. Other Phase I studies aim to investigate how the new drug is absorbed, distributed, metabolized and excreted. Phase IIa is typically conducted in up to 100 patients with the disease of interest. Studies in this Phase aim to show that the new drug has a useful amount of the desired clinical activity (e.g., that an experimental antihypertensive drug reduces blood pressure by a useful amount) and can be tolerated when given to humans in the longer term, and to investigate which dose levels might be most suitable for eventual marketing.

Proof of Biology (PoB) generally refers to a demonstration via pre-clinical testing of clinical feasibility, for example through the use of biomarkers as surrogate endpoints to early clinical trials. In early development it is not practical to directly measure that a drug is effective in treating the desired disease, thus a surrogate endpoint can be used to guide whether or not it is appropriate to proceed with further testing. For example, while it cannot be determined prior to clinical trials that a new antibiotic cures patients with pneumonia, early indicators of this possibility may include the antibiotic's effectiveness in killing bacteria in laboratory tests, meriting further testing. As another example, PoB could be based on showing that the drug interacts with the intended molecular receptor or enzyme and/or affects cell biochemistry in the desired manner and direction.

Proof of Relevance (PoR) generally refers to the ability to recognize and communicate the indisputable clinical and commercial value of pharmaceutical product candidates at early stages of development.

As an example, in one embodiment, a question/market that assesses the outcome of a milestone/goal relates to a biomarker assay achieving efficacy for indicating usefulness of a pharmaceutical preclinical or clinical product candidate for a certain indication. In a further embodiment, the question/market assesses the ability of achieving said efficacy for the biomarker assay within a certain period of time.

In one embodiment of the present invention, and as an example, the project with the business uncertainty is in the field of pharmaceutical research and development in the oncology area.

In another embodiment, the methods of the present invention may be used to determine whether a stock market “view” (i.e., the level of a publicly listed company's stock price) accurately reflects the likelihood of a particular business-related project achieving a stated objective. In this embodiment, a prediction market generated by the described methods can be used, for example, to assess whether and at what price per share a second company may sensibly risk investing in and/or acquiring the stocks of a publicly-traded company, wherein said publicly-traded company owns or controls the business project with the uncertain timeline and/or uncertain results (e.g., development of a product) that is of interest to said second company. A prediction market generated by the disclosed methods may be used to guide decisions to invest in either “long” or “short” positions of the publicly-traded equity. The target group of participants would have access to only publicly available information about the project with business uncertainties and/or the specific milestone/goal at hand. This “market arbitrage” embodiment relies on the fact that the share price of a publicly-traded company may have been set inefficiently (i.e., in a manner that does not accurately reflect the probability of the achieving the stated objective) by the stock market. This inefficiency is “discovered” by polling a cohort of knowledgeable and expert individuals through the prediction market mechanism of the present invention.

As an example, suppose a biopharmaceutical company is a publicly traded company with its shares listed on a stock exchange for publicly traded companies). The company is developing a drug for the treatment of a disease. Based on publicly available information, including the statements of the company with respect to the market potential, probability of success, competitive potential and other information of and related to drug, the company's stock is trading in a range between $40 and $45, indicating an assumption by the stock market participants trading the stock that the likelihood of success of an on-going Phase III clinical trial is relatively high. As this is the company's most advanced drug development program, and the main determinant of the company's valuation, the company's share price is sensitive to the outcome of the Phase III clinical trial. Should it succeed, it might be expected that the stock price would increase, and should it fail it would be expected that the share price would fall dramatically. Suppose the Phase III trial fails and, within 3 days of this occurrence, the company issues an announcement about the failure of the program. The share price of the company then falls dramatically as the company's valuation is materially and negatively impacted by this drug development program.

Suppose that prior to the biopharmaceutical company's announcement, an investment company created a prediction market using the method that is the subject of the present invention to address the question of the probability of success of the clinical trial to a target group of diverse knowledge experts in the field of drug development. Also suppose that these relative experts (relative to the overall participants in the stock market), based purely on publicly available information but with a greater knowledge of the field of drug development, expressed through the prediction market that the clinical trial had a greater probability of failure than success. Using the prediction of the prediction market, the investment company may have entered into a short sale of the biopharmaceutical company's stock in advance of the announcement of the clinical trial results. As a consequence, when the clinical trial failure is announced, there will be a positive return on the investment company's investment.

Similarly, the investment company may observe that the stock market as a whole has a view that a clinical trial of a second public biopharmaceutical company is likely to fail. A target group of diverse knowledge experts, polled by the investment company via a prediction market generated as described herein, may take the view (based only in publicly available information) that the clinical trial is likely to succeed. In this scenario, the investment company may purchase the biopharmaceutical company's stock (take a “long” position). If the clinical trial is successful, as predicted by the prediction market, then the company's stock will appreciate, and the investment company will see a return on their investment as a consequence of this stock price increase.

Thus, the present invention relates to a method of using a prediction market data output and the information provided therein, generated as described herein, to determine whether to invest in or acquire stock of a publicly-traded company, comprising: (a) generating one or more prediction markets using a method as described in this application, wherein the project with the uncertain timeline and/or uncertain result is owned or controlled by the publicly-traded company, and wherein if more than one prediction market is generated, they differ with regard to the milestone/goal that is the subject of the prediction market, the question asked, and/or the answer choices provided; and, (b) analyzing the relative probabilities of potential outcomes calculated in step (a) to determine whether to invest in or acquire stock of the publicly-traded company. In one embodiment, the project relates to a commercial pharmaceutical product or preclinical or clinical pharmaceutical product candidate. In the alternative, the project relates to products in development in other high-tech industries.

A prediction market data output generated by the methods disclosed also can be used to help assess whether a corporation or organization should acquire or license a commercialized product or product in development (i.e., a product candidate) from a third party that owns or controls the development of said product or product candidate. Thus, one embodiment of the present invention relates to a method of using a prediction market generated as described herein to determine whether to acquire or commercially license a commercialized product or a product candidate from a third-party, wherein the product or product candidate is owned or controlled by said third-party, comprising: (a) generating one or more prediction markets by methods as described in this application, wherein the project with the uncertain timeline and/or uncertain result relates to the product or product candidate, and wherein if more than one prediction market is generated, they differ with regard to the milestone/goal that is the subject of the prediction market, the question asked, and/or the answer choices provided; and, (b) analyzing the relative probabilities of potential outcomes calculated in step (a) to determine whether to acquire or commercially license the product or product candidate. In one embodiment, the project relates to a commercial pharmaceutical product or preclinical or clinical pharmaceutical product candidate. In the alternative, the project relates to products in development in other high-tech industries.

A prediction market process described as part of the present invention can be sponsored by one or more persons or entities that set the parameters, including but not limited to, identifying the project and the event, devising the questions and answers, determining the length of the market and the incentive structure, if any, and identifying the target participant group.

### EXAMPLES

### Example 1

In this example, the markets followed a pari-mutuel betting format. The same 16 questions (“markets”) appeared each week for seven weeks, each focused on the oncology disease area. The milestones/goals of the markets were either short term or long term goals. Each week, 100 participants were each given 10 points per question to allocate across the fixed answer choices (i.e., potential outcomes) for each question. Each week, 1000 points (100 participants×10 points each) were allocated across the answer choices for each of the markets. Tracking the allocation of these 1000 points allowed the determination of the crowd's certainty in predicting the outcome of the question/market.

An example of one of the 16 questions is as follows: When will Product Candidate X achieve proof of concept in any indication?

The fixed answers choices were as follows: (a) Ahead of schedule (<4Q 2009); (b) Within expected range (4Q 2009-2Q 2010); (c) Behind schedule (3Q 2010-4Q 2010); (d) Compound discontinued by the end of 4Q 2010; or, (e) No resolution by the end of 4Q 2010.

The participants were given the following general guidance:

Participating is Simple:
Log on and make predictions each week (Tuesday-Sunday), once per week.
Every question is called a “market.” You will be given 10 weight points per market.
For each market, allocate your weight points across the answers according to your opinion of the most likely outcome(s). If you are 100% certain of an outcome, then you should place all 10 of your points for that question in that option. If there are 5 potential outcomes in a market, and you believe all are equally likely to occur, you should place 2 points in each option.
The same questions/markets will appear each week, allowing you to change your predictions as you gather new information.
For each question/market, you will see how others predicted the outcome during previous week. This can help inform your next allocation.
Take your best guess. Awards will be issued to the most active participants and the best predictors!

Prediction behaviors over the course of the seven week experiment were monitored. The point allocations between the answer choices for each particular question indicated the general market consensus of the most likely outcome. There were 1000 weight points allocated across the answer choices for each market (10 points from each of the 100 participants). If 500 points were allocated to a particular outcome, the market was predicting that outcome with 50% certainty overall. As the allocation changed over time, so too did the market's overall prediction.

Aside from participation rewards, no awards were realized until the event in the market had been resolved. When an event occurred and the market was therefore resolved (i.e., an outcome was determined), awards were given according to the odds that resulted from each discrete week. Since there were 7 weeks of experiment, awards for predicting the correct outcome (i.e., choosing the ultimately accurate answer) varied for each week of predicting.

In addition to indicating the general market consensus of the most likely outcome, predictions were segmented by the participants' function within the organization to identify whether different functions had consensus insight of the risks associated specific business or technical objective of the project.

### Example 2

In this example, a target group of individuals with relevant knowledge related to the subject matter of a project, and wherein the target group is cognitively diverse regarding the subject matter of the project, were invited to participate in a prediction market exercise. The target group included employees of a large pharmaceutical company having the following roles or responsibilities within the company: early discovery, clinical development, marketing, product portfolio management, project management, statistics, tax, safety assessment, human resources, and IT. Some of the participants in the target group had specific knowledge in the field of oncology. Of the invited participants, 86% registered to participate, and 83% of the registered participants submitted predictions on at least one market/question

### Question 1:

An objective for the Oncology franchise this year is a second quarter (Q2) milestone to determine if a gene expression signature can be qualified as a target engagement biomarker for Product Candidate Y. When and how will the issue be resolved?
Fixed answer choices: (a) When: resolved in Q2/How: signature qualified; (b) When: resolved in Q2/How: signature not qualified; (c) When: resolved in Q3 or Q4/How: signature qualified; (d) When: resolved in Q3 or Q4/How: signature not qualified; or, (e) Experiment will fail to provide resolution this year.
The prediction market graph of the participants' predictions for this market/question is shown in FIG. 1. From May/24-May/31, there were rumors that the milestone was about to be reached and the signature qualified. The results in FIG. 1 show that the market drastically shifted predictions to adjust for the new information. The implication is that prediction markets can potentially respond to newly apparent information, still not formally disseminated.

### Question 2:

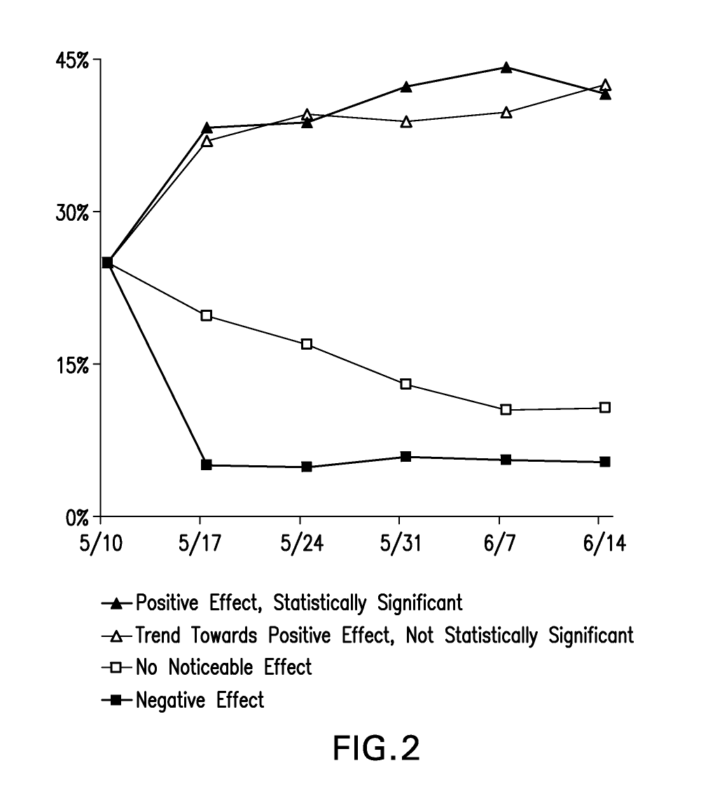

At the American Society of Clinical Oncology (ASCO) conference, data on Drug Compound Z will be presented from the National Cancer Institute Cancer Therapy Evaluation Program studies on non-small cell lung carcinoma patients who have been administered Drug Compound Z. What will the effect be of Drug Compound Z (a commercial product for the treatment of cutaneous T-cell lymphoma)?
Answer choices: (a) Positive effect, statistically significant; (b) Trend towards positive effect, not statistically significant; (c) No noticeable effect; or, (d) Negative effect.
The prediction market graph of the participants' predictions is shown in FIG. 2. It was found that 75-84% of cumulative predictions predicted that the effect of Drug Compound Z would be positive. The overwhelming sentiment of the crowd correctly hypothesized the directionality of the result presented at the conference. The implication is that prediction markets can potentially equip an organization with an organized way to predict external data.

### Question 3:

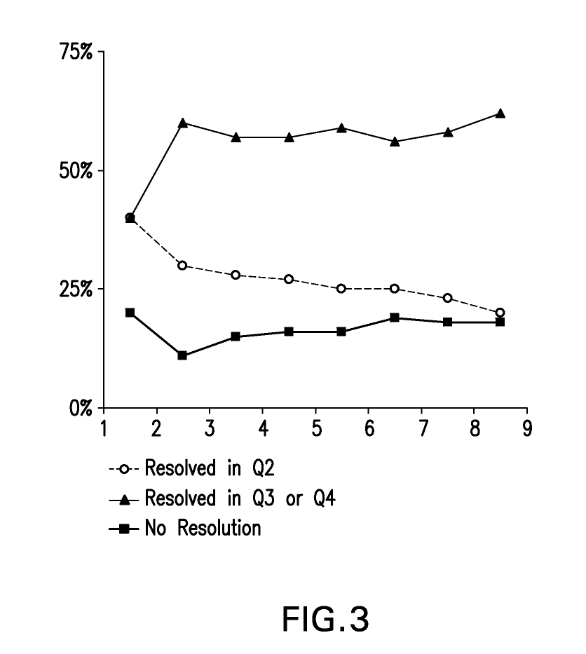

An objective for Company X's Oncology program this year is a second quarter (Q2) milestone to determine if Product Candidate K can achieve proof of biology (PoB). When/how will the issue be resolved?
Answer choices: (a) Resolved in Q2 (PoB achieved or PoB not achieved); (b) Resolved in Q3 or Q4 (PoB achieved or PoB not achieved); or, (c) No resolution.
The prediction market graph of the participants' predictions is shown in FIG. 3. Although the market did not reveal an overwhelming crowd sentiment or shift regarding outcome, it seemed to reveal a strong sentiment on the timeline of resolution. The participants possibly had more information on timeline risk than outcome risk. The implication is that prediction markets can potentially help an organization isolate timeline uncertainty from technical uncertainty, which can aid the organization in planning.

### Example 3

In this example provides examples of potential markets/questions and fixed answer choices that may be used in the methods for generating prediction markets of the present invention.

### Market/Question:

Oil may be discovered in Field X. When will the oil be discovered?

### Answer Choices:

(a) On or before Dec. 31, 2015; (b) Between Jan. 1, 2016 and Dec. 31, 2018; (c) Between Jan. 1, 2019 and Dec. 31, 2021; (d) Not before Dec. 31, 2021; or, (e) Never.

### Market/Question:

One pharmaceutical company is considering licensing a product candidate (e.g., drug or device) owned or controlled by a third party (e.g., pharmaceutical or biotechnology company, or university). What is the probability of successfully developing and marketing such product candidate?

### Answer Choices:

(a) 0-20%; (b) 21-40%; (c) 41-60%; (d) 61-80%; or, (e) 81-100%.

### Market/Question:

Pharmaceutical Company X is developing Drug Y for Indication Z. The current clinical trial is aiming to demonstrate proof of concept in this indication. What is the probability of Drug Y demonstrating proof of concept in this clinical trial?

### Answer Choices:

(a) 0-20%; (b) 21-40%; (c) 41-60%; (d) 61-80%; or, (e) 81-100%.

Although various exemplary embodiments have been described, it not intended to be limited to the specific form set forth herein. Rather, the scope of the present invention is limited by the claims. Additionally, although a feature may appear to be described in connection with a particular exemplary embodiment, one skilled in the art would recognize that various features of the described exemplary embodiments may be combined. Moreover, aspects of various exemplary embodiments may stand alone as an invention.

While the present invention has been described in conjunction with the specific embodiments set forth above, many alternatives, modifications and variations thereof will be apparent to those of ordinary skill in the art. All such alternatives, modifications and variations are intended to fall within the spirit and scope of the present invention.

What is claimed is:

1. A method for generating a prediction market data output of relative probabilities for choosing a particular answer choice for a question related to an event occurring in the future using a prediction market computer system comprising a user interface, a probability calculator module, a data output module and a database, the method comprising:
(a) receiving in a first prediction period via the user interface a first prediction input from each of two or more participants of a target group, wherein the first prediction input comprises a participant's allocation of a fixed number of weight points across fixed answer choices for the question, wherein the answer choices represent potential outcomes for the event, and wherein only one of said fixed answer choices can be an actual outcome for said event;
(b) recording each of said first prediction inputs in the database;
(c) executing the probability calculator module to calculate a response ratio for each answer choice, wherein the response ratio is a predicted odds for choosing a particular answer choice based on comparing sum total weight points allocated to each answer choice in the first prediction period to sum total weight points allocated in the first prediction period;
(d) receiving in a subsequent prediction period via the user interface a subsequent prediction input from each of two or more participants of the target group, wherein:
(i) subsequent prediction periods occur on a periodic basis after the first prediction period;
(ii) each subsequent prediction input comprises a participant's allocation of a fixed number of weight points across fixed answer choices;
(iii) the fixed number of weight points and the fixed answer choices are the same as in the first prediction period; and,
(iv) each participant is provided the response ratio for each answer choice calculated in the previous prediction period prior to allocating the weight points;
(e) recording each of said subsequent prediction inputs in the database;
(f) executing the probability calculator module to calculate for each subsequent prediction period the response ratio for each answer choice in said subsequent prediction period, wherein the response ratio is the predicted odds for choosing a particular answer choice based on comparing sum total of weight points allocated to each answer choice in said subsequent prediction period to sum total number of weight points allocated in said subsequent prediction period;
(g) repeating steps (d)-(f) either until a point in time either prior to or until the actual outcome for said event occurs, wherein market length is set when prediction inputs cease; and,
(h) executing the data output module to display the response ratio for each answer choice per prediction period over the market length, generating the prediction market data output.

2. A method of claim 1, wherein the user interface is configured to display on a display screen of a human output device of each participant of the target group the question, the fixed answer choices, the fixed number of weight points, and optionally the response ratio for each answer choice as calculated from the previous prediction period.

3. A method of claim 2, wherein the event is a milestone that represents a specific business or technical objective.

4. A method of claim 3, wherein each participant of the target group has relevant knowledge related to the specific business or technical objective, and the target group is cognitively diverse regarding the specific business or technical objective.

5. The method of claim 4, wherein the specific business or technical objective relates to a commercial pharmaceutical product or a preclinical or clinical pharmaceutical product candidate.

6. The method of claim 5, wherein the pharmaceutical product or product candidate is owned or controlled by a publicly-traded company.

7. The method of claim 6, wherein the specific business or technical objective is publicly-stated.

8. The method of claim 5, wherein the specific business or technical objective relates to a preclinical or clinical pharmaceutical product candidate.

9. The method of claim 8, wherein the specific business or technical objective relates to the preclinical or clinical pharmaceutical product achieving a positive result in a clinical trial.

10. The method of claim 8, wherein the specific business or technical objective relates to the pharmaceutical product candidate achieving Proof of Biology (POB) for a certain indication.

11. The method of claim 10, wherein the specific business or technical objective further relates to achieving POB for a certain indication within a certain period of time.

12. The method of claim 8, wherein the specific business or technical objective relates to the pharmaceutical product candidate achieving Proof of Concept (POC).

13. The method of claim 12, wherein the specific business or technical objective further relates to achieving POC within a certain period of time.

14. The method of claim 1, wherein the market length is one year or less.

15. The method of claim 1, wherein the market length is longer than one year.

16. The method of claim 1, wherein “periodic basis” refers to a frequency selected from the group consisting of once every three days, once a week, once every two weeks, once every three weeks and once a month.

17. The method of claim 16, wherein “periodic basis” refers to once per week, and “previous prediction period” refers to the previous week.

18. The method of claim 1, wherein the fixed number of weight points is selected from a group consisting of 1 weight point, a number that allows equal distribution of the weight points across the answer choices, and a number greater than 1 and that forces an unequal distribution of weight points across the answer choices.

19. The method of claim 5, wherein one or more of the participants are selected from individuals who have knowledge in the field of (i) pharmaceutical manufacturing, (ii) clinical studies associated with pharmaceutical products and/or product candidates, (iii) business development in the pharmaceutical industry, (iv) marketing in the pharmaceutical industry, (v) regulatory compliance and law associated with pharmaceuticals, and/or (vi) basic biology or chemistry science.

20. The method of claim 19, wherein the pharmaceutical product or product candidate is in the field of oncology, and the participants are individuals who have knowledge in the field of oncology.

21. The method of claim 1, wherein the number of participants submitting a prediction input in a single prediction period ranges from 2 to 100,000.

22. The method of claim 2, wherein an incentive is further displayed on the display screen of the human output device of each participant of the target.

23. The method of claim 1, wherein the database includes one or more of the following group of data files: prediction input files, response ratio files, prediction market data output files, and participant meta-tag data files.

24. An apparatus for generating a prediction market data output of relative probabilities for choosing a particular answer choice for a question related to an event occurring in the future, the apparatus comprising:
a microprocessor;
a user interface module comprising program instructions that, when executed by the microprocessor, enables display via a network interface on a display screen of a human output device of each participant of a target group on a periodic basis:
(1) the question;
(2) fixed answer choices representing potential outcomes for said event, wherein only one of said fixed answer choices can be an actual outcome for said event;
(3) a fixed number of weight points;
(4) a request and instructions to participate in a prediction market process, wherein said prediction market process comprises the participant submitting a prediction input on said periodic basis that is received and recorded by the apparatus, and wherein the prediction input comprises the participant's allocation of the weight points across the answer choices; and,
(5) for each prediction period after a first prediction period, a response ratio for each answer choice chosen in the previous prediction period, wherein a response ratio is a predicted odds for choosing a particular answer choice based on comparing sum total weight points allocated to each answer choice in a prediction period to sum total weight points allocated in a prediction period;
a probability calculator module comprising program instructions that, when executed by the microprocessor, calculates from the prediction inputs received in a single prediction period the response ratio for each answer choice in said single prediction period; and,
a prediction market data output module comprising program instructions that, when executed by the microprocessor, generates a data output of the response ratio for each answer choice per prediction period over market length.

25. The apparatus of claim 24, wherein the prediction inputs are received in the form of an input text file.

26. The apparatus of claim 24, further comprising a data storage device that stores a plurality of prediction input data files and memory for storing said data files.

27. The apparatus of claim 26, wherein the data storage device comprises more than one individual data storage databases.

28. The apparatus of claim 26, further comprising a participant analysis module comprising program instructions that, when executed by the microprocessor, extracts and tags participant data stored with the data storage device, parsing the participant data into subsets of participants with a particular characteristic.

29. The apparatus of claim 27, further comprising a database management module comprising program instructions that, when executed by the microprocessor, organizes stored data files and facilitates storing and retrieving files to and from the data storage device databases.
